(19) United States
(12) Patent Application Publication
(10) Pub. No.: US 2013/0266164 A1
(43) Pub. Date: Oct. 10, 2013

(54) SPEECH RECOGNITION SYSTEM FOR FITTING HEARING ASSISTANCE DEVICES

(71) Applicant: William S. Woods, Berkeley, CA (US)

(72) Inventor: William S. Woods, Berkeley, CA (US)

(73) Assignee: Starkey Laboratories, Inc., Eden Prairie, MN (US)

(21) Appl. No.: 13/443,171

(22) Filed: Apr. 10, 2012

(51) Int. Cl. H04R 25/00

(52) U.S. Cl. 381/314

(57) ABSTRACT

Disclosed herein, among other things, are apparatus and methods to provide improved fitting and programming of hearing assistance devices. One aspect of the present subject matter includes a system for fitting a hearing assistance device. In one embodiment, the system includes a programmer and a hearing assistance device configured to receive a transmission including commands and information from the programmer. The programmer is configured to receive voice commands for fitting the hearing assistance device and to initiate transmissions to the hearing assistance device using speech recognition, in various embodiments. The transmissions are used to provide control of the function or settings of the hearing assistance device. In one embodiment the programmer includes a personal computer. The programmer includes a cellular telephone, in one embodiment. Other embodiments are possible without departing from the scope of the present subject matter.

### FIELD OF THE INVENTION

The present subject matter relates generally to hearing assistance devices, and in particular to a speech recognition system for fitting hearing assistance devices.

### BACKGROUND

Hearing assistance devices, such as hearing aids, typically include a signal processor in communication with a microphone and receiver. Such designs are adapted to process sounds received by the microphone. Modern hearing aids are programmable devices that have settings made based on the hearing and needs of an individual patient. Such customization is typically a part of fitting the hearing aid to the wearer.

Clinicians and dispensers work one-on-one with the patient when fitting and adjusting hearing aids. This process entails frequent switching of attention between the patient and the software used to change the hearing aid processing, sometimes with prolonged searching through a multi-paged graphical user interface to find the desired controls. This switching and searching increases the time needed to complete the fitting process, and also breaks the personal connection between fitter and patient. In addition, navigating and performing repeated, multi-step actions with fitting software can be cumbersome. Accordingly, there is a need in the art for apparatus and methods for hearing aid fitting that minimize the amount or extent of switching and searching the clinician or dispenser must perform.

### SUMMARY

Disclosed herein, among other things, are apparatus and methods to provide improved fitting and programming of hearing assistance devices. The present apparatus and method can be deployed on the hearing assistance device, a device in communication with the hearing assistance device, or on both. One aspect of the present subject matter includes a system for fitting a hearing assistance device. In one embodiment, the system includes a programmer and a hearing assistance device configured to receive a transmission including commands and information from the programmer. The programmer is configured to receive voice commands for fitting the hearing assistance device and to initiate transmissions to the hearing assistance device using speech recognition, in various embodiments. The transmissions are used to provide control of the function or settings of the hearing assistance device. In one embodiment the programmer includes a personal computer. The programmer includes a cellular telephone, in one embodiment. Other embodiments are possible without departing from the scope of the present subject matter.

This Summary is an overview of some of the teachings of the present application and not intended to be an exclusive or exhaustive treatment of the present subject matter. Further details about the present subject matter are found in the detailed description and appended claims. The scope of the present invention is defined by the appended claims and their legal equivalents.

### BRIEF DESCRIPTION OF THE DRAWINGS

FIG. 1A demonstrates one example of a programming system for hearing aids, according to one embodiment of the present subject matter.

FIG. 1B demonstrates another example of a programming system for hearing aids, according to one embodiment of the present subject matter.

FIG. 2A demonstrates another example of a programming system for hearing aids, according to one embodiment of the present subject matter.

FIG. 2B demonstrates another example of a programming system for hearing aids, according to one embodiment of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment. The following detailed description is demonstrative and not to be taken in a limiting sense. The scope of the present subject matter is defined by the appended claims, along with the full scope of legal equivalents to which such claims are entitled.

The present detailed description will discuss hearing assistance devices using the example of hearing aids. Hearing aids are only one type of hearing assistance device and it is understood that their use in the description is intended to demonstrate the present subject matter, but not in a limited or exclusive sense. Modern hearing aid designs are highly programmable and require innovative approaches to controlling the hearing aid. Such designs may also be wireless and may communicate with other devices having programmable controls to provide controllable functions or settings.

The embodiments described herein focus on, among other things, programming hearing aid systems. One component of a hearing aid system includes a processing system. The processing system provides audio signal processing. In various embodiments, the processing system includes a controller or processor. The processor may be any type of processor including RISC, CISC, VLIW, MISC, OISC, and may include a Digital Signal Processor (“DSP”). In one embodiment, the processor communicates with an RF receiver and RF transmitter to transmit and receive wireless signals such as cellular, Bluetooth, and Wi-Fi signals. The processor may use short term memory to store operating instructions and help in the execution of the operating instructions such as the temporary storage of calculations and the like. The processor may also use non-transitory storage to read instructions, files, and other data that requires long term, non-volatile storage.

The audio signal processing includes audiological parameters that may be adjusted so as to enhance the sense of hearing for a patient. This adjustment of the audiological parameters is a tailoring (or fitting) of an audiological therapy for a specific patient. In tailoring, the patient is tested to obtain aural responses to various conditions. These responses are then used to determine which audiological parameters to adjust as well as the ranges of audiological parameter values that may be adjusted. Different brands of hearing aid may have different audiological parameters. This process of adjustment may be considered a programming of the hearing aid system.

In various embodiments, parameters of the hearing assistance device are adjusted using the fitting system. Fitting data includes, but is not limited to, one or more of: frequency dependent gain information, acoustic feedback canceller information, noise management information, selectable parameters, mode selection information, and/or other settings for a hearing assistance device. Collectively, fitting data may be considered a hearing assistance device profile.

Clinicians and dispensers work one-on-one with the patient when fitting and adjusting hearing aids. This process entails frequent switching of attention between the patient and the software used to change the hearing aid processing, sometimes with prolonged searching through a multi-paged graphical user interface to find the desired controls. This switching and searching increases the time needed to complete the fitting process, and also breaks the personal connection between fitter and patient. In addition, navigating and performing repeated, multi-step actions with fitting software can be cumbersome. While training of clinicians and dispensers on the use of fitting software can improve the process, it can be time consuming and expensive. Other shortcuts, such as setting defaults and using macros or “hot keys” have also been attempted, but require substantial familiarity with the software. Accordingly, there is a need in the art for apparatus and methods for hearing aid fitting that minimize the amount or extent of switching and searching the clinician or dispenser must perform.

Disclosed herein, among other things, are apparatus and methods to provide improved fitting and programming of hearing assistance devices. One aspect of the present subject matter includes a system for fitting a hearing assistance device. In one embodiment, the system includes a programmer and a hearing assistance device configured to receive a transmission including commands and information from the programmer. The programmer is configured to receive voice commands for fitting the hearing assistance device and to initiate transmissions to the hearing assistance device using speech recognition, in various embodiments. The transmissions are used to provide control of the function or settings of the hearing assistance device. In one embodiment the programmer includes a personal computer. The programmer includes a cellular telephone, in one embodiment. In various embodiments, the function or settings of the hearing aid are controlled using voice commands via a microphone input and voice recognition software and hardware. Other embodiments are possible without departing from the scope of the present subject matter. In one embodiment, a gestural interface is used instead of or in addition to the speech recognition interface.

The present subject matter provides several benefits, including making interaction between an audiologist, clinician, or dispenser (or other fitter) and the fitting software easier, more intuitive and seamless. The voice command interface of the present subject matter requires less training and provides an improved interface for hearing assistance device fitting. In various embodiments, speech recognition is used by a programmer device to improve the fitting process, allowing voice commands by the fitter to control the fitting software rather than (or in addition to) direct manipulation via mouse or keyboard or other tangible interface. The speech recognition acts like an informed assistant, or “technician”, sitting at the mouse and keyboard. Rather than running the mouse and keyboard by themselves, the fitter speaks the desired action and the “technician” carries out the action.

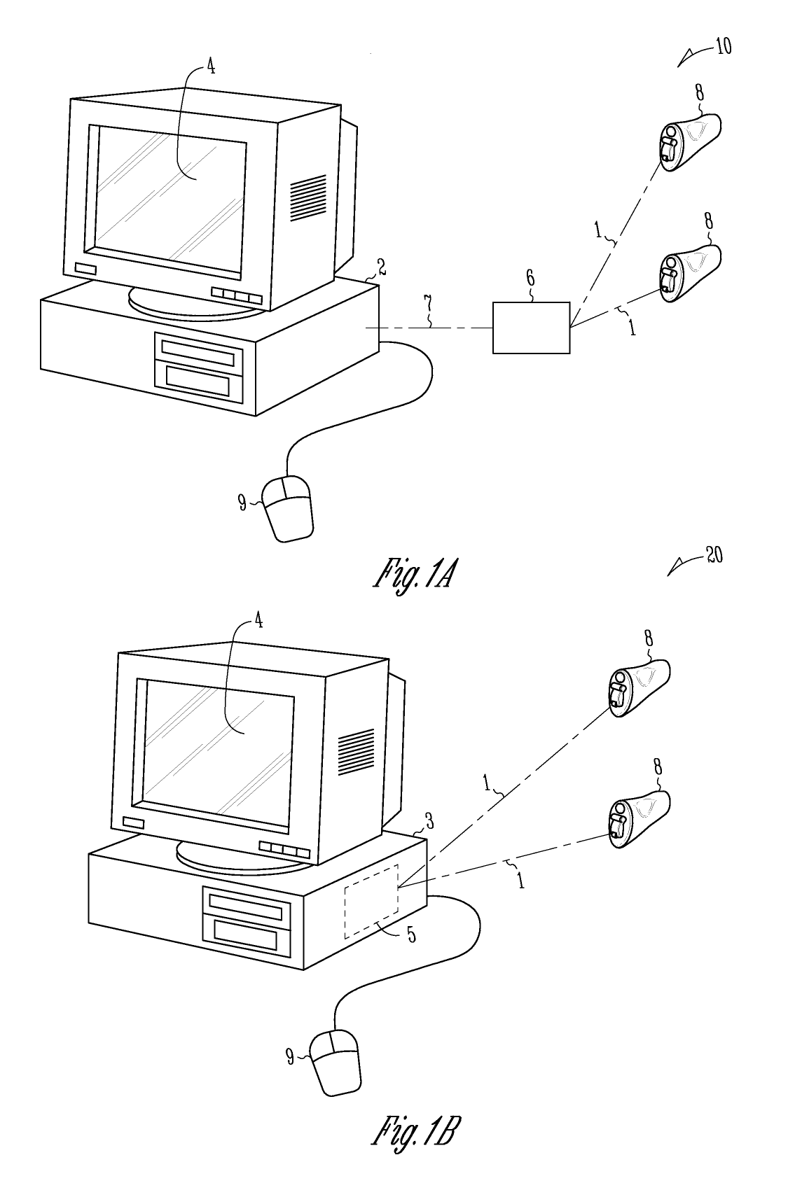

FIG. 1A demonstrates one example of a programming system 10 for hearing aids, according to one embodiment of the present subject matter. Computer 2 communicates with hearing aids 8 via programmer 6. Communications may be conducted over link 7 either using wired or wireless connections. Communications 1 between programmer 6 and hearing aids 8 may be conducted over wired, wireless or combinations of wired and wireless connections. It is further understood that hearing aids 8 are shown as completely-in-the-canal (CIC) hearing aids, but that any type of devices, including but not limited to, in-the-ear (ITE), behind-the-ear (BTE), receiver-in-the-canal (RIC), cochlear implants, headphones, and hearing assistance devices generally as may be developed in the future may be used without departing from the scope of the present subject matter. It is further understood that a single hearing aid may be programmed and thus, the present subject matter is not limited to dual hearing aid applications. Computer 2 is shown as a desktop computer, however, it is understood that computer 2 may be any variety of computer, including, but not limited to, a laptop, a tablet personal computer, or other type of computer as may be developed in the future. Computer 2 is shown as having a screen 4. The screen 4 is demonstrated as a cathode ray tube (CRT), but it is understood that any type of screen may be used without departing from the scope of the present subject matter. Computer 2 also has an input device 9, which is demonstrated as a mouse; however, it is understood that input device 9 can be any input device, including, but not limited to, a touchpad, a joystick, a trackball, or other input device. An input interface facilitates input from users of the fitting software. Inputs include, but are not limited to, pointer device, touch, voice, gesture, and keyboard inputs. A user of fitting software uses one or more of the input methods to interact with the fitting software and adjust one or more parameters of the hearing assistance device.

FIG. 1B demonstrates another example of a programming system 20 for hearing aids, according to one embodiment of the present subject matter. In FIG. 1B, computer 3 has internal programming electronics 5 which are native to the computer 3. For like-numbered components, the discussion above is incorporated by reference. Communications 1 between computer 3 and hearing aids 8 may be conducted over wired, wireless or combinations of wired and wireless connections. Computer 3 is shown as a desktop computer, however, it is understood that computer 3 may be any variety of computer, including, but not limited to, a laptop, a tablet personal computer, or other type of computer as may be developed in the future.

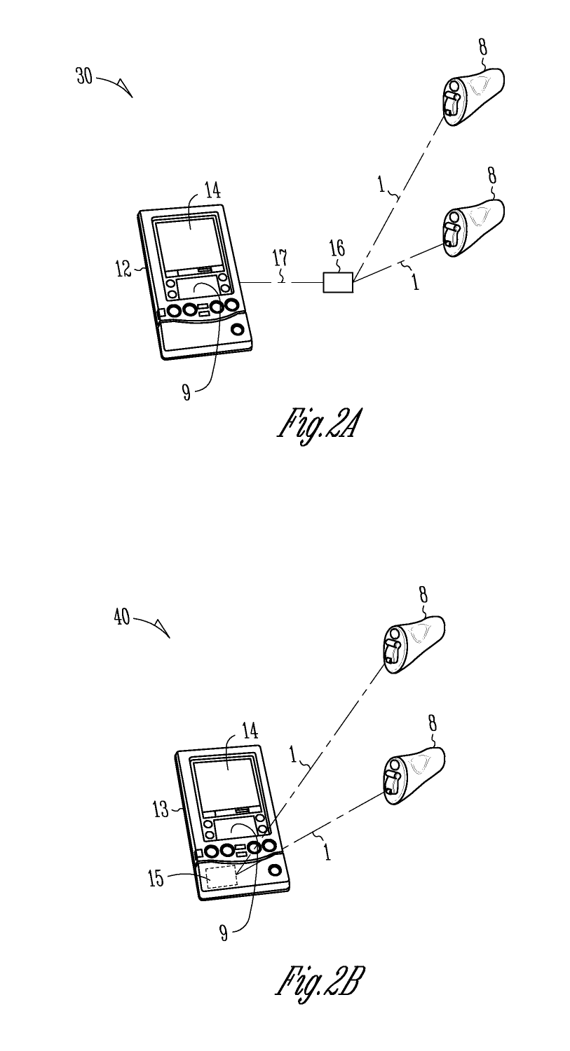

FIG. 2A demonstrates another example of a programming system 30 for hearing aids, according to one embodiment of the present subject matter. The handheld device 12 communicates with hearing aids 8 via programmer 16. Communications may be conducted over link 17 either using wired or wireless connections. Communications 1 between programmer 16 and hearing aids 8 may be conducted over wired, wireless or combinations of wired and wireless connections. It is further understood that hearing aids 8 are shown as completely-in-the-canal (CIC) hearing aids, but that any type of devices, including but not limited to, in-the-ear (ITE), behind-the-ear (BTE), receiver-in-the-canal (RIC), cochlear implants, headphones, and hearing assistance devices generally as may be developed in the future may be used without departing from the scope of the present subject matter. It is further understood that a single hearing aid may be programmed and thus, the present subject matter is not limited to dual hearing aid applications. Handheld device 12 is demonstrated as a cell phone, however, it is understood that handheld device 12 may be any variety of handheld computer, including, but not limited to, a personal digital assistant (PDA), an IPOD, or other type of handheld computer as may be developed in the future. Handheld device 12 is shown as having a screen 14. The screen 14 is demonstrated as a liquid crystal display (LCD), but it is understood that any type of screen may be used without departing from the scope of the present subject matter. Computer 2 also has various input devices 9, including buttons and/or a touchpad; however, it is understood that any input device, including, but not limited to, a joystick, a trackball, or other input device may be used without departing from the present subject matter. An input interface facilitates input from users of the fitting software. Inputs include, but are not limited to, pointer device, touch, voice, gesture, and keyboard inputs. A user of fitting software uses one or more of the input methods to interact with the fitting software and adjust one or more parameters of the hearing assistance device.

FIG. 2B demonstrates another example of a programming system 40 for hearing aids, according to one embodiment of the present subject matter. In FIG. 2B, handheld device 13 has internal programming electronics 15 which are native to the handheld device 13. For like-numbered components, the discussions above are incorporated by reference. Communications 1 between handheld device 13 and hearing aids 8 may be conducted over wired, wireless or combinations of wired and wireless connections. Handheld device 13 is shown as a cell phone, however, it is understood that handheld device 13 may be any variety of handheld computer, including, but not limited to, a personal digital assistant (PDA), an IPOD, or other type of handheld computer as may be developed in the future.

A number of control functions are programmable using the fitting system. Some of these control functions include but are not limited to the following: to change between omnidirectional and directional microphone modes; to alter the input among induction coil (alone), induction coil & microphone (mixed), omni and/or directional microphone, direct audio input, audio input via frequency modulation (FM) transmission, audio input via 900 MHz wireless transmission; and programmable combinations thereof; to initiate a device self diagnostic, where the head worn device tests its own components (some examples include but are not limited to a test of its microphone(s), receiver, circuitry, EEPROM, digital signal processor, and/or power supply) and communicates the diagnostic results to the user of the device or a professional; to create an audio or statistical recording of an environment, to save the recording and to allow retrieval/replay of the recording; to initiate or activate a self-learning algorithm in the head worn device and/or remote control; and/or to pause or resume audio streaming of an audio signal.

It is understood that other communications frequencies may be employed in different geographical regions. Furthermore, it is understood that bidirectional and unidirectional communication modes are possible. The configurations and examples set forth herein are intended to demonstrate the present subject matter and not in an exhaustive or exclusive sense.

The present subject matter can be used for a variety of hearing assistance devices, including but not limited to, assistive listening devices, tinnitus masking devices, cochlear implant type hearing devices, hearing aids, such as behind-the-ear (BTE), in-the-ear (ITE), in-the-canal (ITC), or completely-in-the-canal (CIC) type hearing aids. It is understood that behind-the-ear type hearing aids may include devices that reside substantially behind the ear or over the ear. Such devices may include hearing aids with receivers associated with the electronics portion of the behind-the-ear device, or hearing aids of the type having receivers in the ear canal of the user, such as receiver-in-the-canal (RIC) or receiver-in-the-ear (RITE) designs. It is understood that other hearing assistance devices not expressly stated herein may fall within the scope of the present subject matter.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

1. A system for fitting a hearing assistance device, the system comprising:
a programmer configured to transmit commands and information to the hearing assistance device,
wherein the programmer is programmed to receive voice commands for fitting the hearing assistance device, process the commands using speech recognition, and to use recognized voice commands to produce transmissions of the commands and the information tier fitting the hearing assistance device.

2. The system of claim 1, wherein the programmer includes a personal computer.

3. The system of claim 1, wherein the programmer includes a cellular telephone.

4. The system of claim 1, wherein the hearing assistance device is a cochlear implant and the programmer is configured to send commands that may by be used by the cochlear implant.

5. The system of claim 1, wherein the programmer is further programmed to receive gesture inputs for fitting the hearing assistance device.

6. The system of claim 1, wherein the hearing assistance device is a hearing aid.

7. The system of claim 6, wherein the hearing aid is a behind-the-ear (BTE) hearing aid.

8. The system of claim 6, wherein the hearing aid is an in-the-ear (ITE) hearing aid.

9. The system of claim 6, wherein the hearing aid is an in-the-canal (ITC) hearing aid.

10. The system of claim 6, wherein the hearing aid is a completely-in-the-canal (CIC) hearing aid.

11. A method for operations by a programmer used fur programming a hearing assistance device, the method comprising:
electronically receiving voice commands fur fitting the hearing assistance device;
processing the voice commands using speech recognition to recognize commands used in fitting the hearing assistance device; and
transmitting programming instructions that can be used to program the hearing assistance device based on the recognized commands.

12. The method of claim 11, further comprising transmitting frequency-dependent gain information for the hearing assistance device based on at least one recognized command.

13. The method of claim 11, further comprising transmitting acoustic feedback canceller information for use by the hearing assistance device based on at least one recognized command.

14. The method of claim 11, further comprising transmitting information relating to noise management related to the hearing assistance device based on at least one recognized command.

15. The method of claim 11, further comprising transmitting mode selection information to the hearing assistance device based on at least one recognized command.

16. The method of claim 11, further comprising sending selectable parameters for the hearing assistance device based on at least one recognized command.

17. The method of claim 11, wherein a personal computer is used at least in part for processing the commands using speech recognition.

18. The method of claim 11, wherein a cellular telephone is used at least in part for processing the commands using speech recognition.

19. The method of claim 11, comprising transmitting wireless transmissions for use by the hearing assistance device.

20. The method of claim 19, comprising transmitting radio frequency transmissions for use by the hearing assistance device.
